(19) United States
(12) Patent Application Publication
(10) Pub. No.: US 2025/0208643 A1
(43) Pub. Date: Jun. 26, 2025

(54) LOADS TO OVERCLOCK CPUS

(71) Applicant: Hewlett-Packard Development Company, L.P., Spring, TX (US)

(72) Inventors: Chihao Lo, Palo Alto, CA (US); Wen-Yen Tseng, Taipei City (TW); Hsih Sung Hsu, Taipei City (TW)

(73) Assignee: Hewlett-Packard Development Company, L.P., Spring, TX (US)

(21) Appl. No.: 18/851,838

(22) PCT Filed: Mar. 30, 2022
(86) PCT No.: PCT/US2022/022671

§ 371 Date: Sep. 27, 2024

(51) Int. Cl. G06F 1/08

(52) U.S. Cl. CPC G06F 1/08

(57) ABSTRACT

An example non-transitory machine-readable medium includes instructions that, when executed by a processor, cause the processor to set a target frequency of a central processing unit (CPU), benchmark the CPU under a first load and a second load, wherein the first load is lighter than the second load, and determine a first operating frequency of the first load and second operating frequency of the second load. If the first operating frequency is lower than the target frequency by a margin and a CPU thermal condition had been met, then the first operating frequency and the second operating frequency are stored for continued operation of the CPU. Otherwise, the benchmark is repeated to redetermine the first operating frequency and the second operating frequency until the first operating frequency is lower than the target frequency by the margin and the CPU thermal condition is met.

### BACKGROUND

A central processing unit (CPU) provides for program execution in a computing device, such as a desktop computer, notebook computer, all-in-one (AiO) computer, or similar. A CPU provides processing throughput that is generally proportional to its operating frequency.

### BRIEF DESCRIPTION OF THE FIGURES

FIG. 1 is a block diagram of an example non-transitory machine-readable medium with instructions to determine a CPU overclocking frequency by testing the CPU under different loads until a frequency for the lightest load falls significantly below a target frequency when thermal intervention is detected.

FIG. 2 is a flowchart of an example method to determine a CPU overclocking frequency by testing the CPU under different loads until a frequency for the lightest load falls significantly below a target frequency when thermal intervention is detected.

FIG. 3 is a block diagram of an example device to determine a CPU overclocking frequency by testing the CPU under different loads until a condition is reached.

### DETAILED DESCRIPTION

It may be useful to set CPU operating frequency as high as practical, so as to enable high processing throughput. Setting a frequency or frequency multiplier to a value that is higher than nominal may be referred to as overclocking the CPU. The risks of overclocking include excessive heat generation that may cause temporary shutdowns or reduced component life, as well as acute damage to a CPU due to elevated voltage often used to help overclocking.

Overclocking has long been a manual process, in which a user applies various software tools to increase their CPU's frequency while monitoring temperature and stability. This approach requires the user to understand their CPU and other components and have the time and skill to obtain, learn, and use the tools.

Automated overclocking techniques have been developed to allow more users to enjoy increased processing throughput with their CPUs. Some automated techniques use algorithms that automatically try various overclocking frequencies and voltages. In addition to being fairly time consuming, this kind of approach often results in crashes due to excessive frequency or voltage, which may alarm users and cause them to abandon the process.

Other approaches collect data from computers and use machine learning to determine suitable overclocking settings. However, such approaches can raise privacy concerns and may require a large amount of computational resources.

The techniques discussed herein determine a suitable overclock frequency for a CPU in an automated manner with reduced demand on the user and on computational resources. A clock frequency of the CPU is increased until a condition is met. At each clock frequency, a benchmark is performed and maximum frequencies are determined for a range of loads applied to the CPU. The condition may be taken as a maximum frequency for the lightest load being significantly below the current clock frequency (e.g., 15% or more below) while detecting thermal intervention at the CPU. Such a condition may be taken to mean that any additional increase to the clock frequency will likely increase the amount of thermal intervention rather than increase processing throughput. Accordingly, the overclocked frequency for the CPU may be selected based on the condition being met.

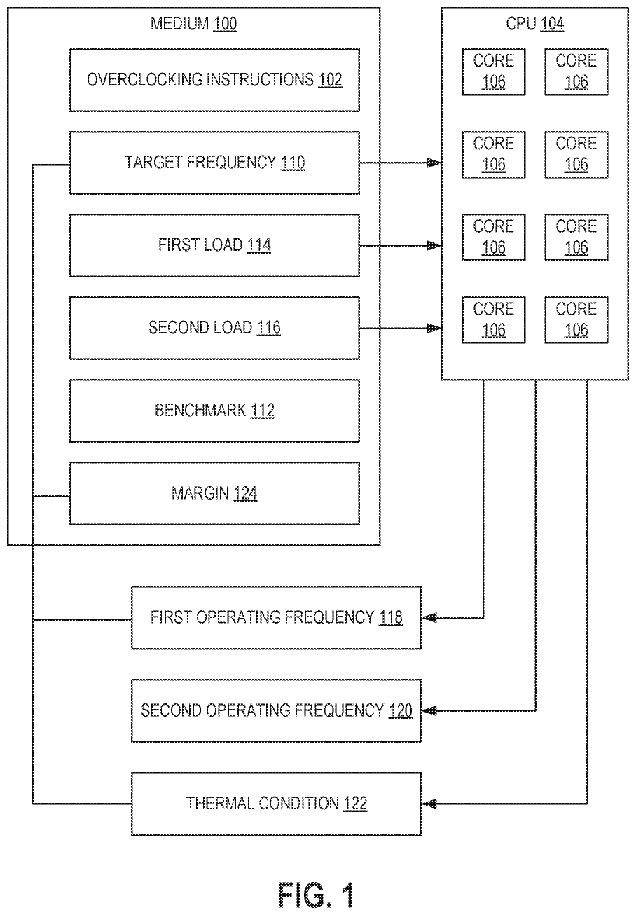

FIG. 1 shows an example non-transitory machine-readable medium 100 with instructions 102 to determine a CPU overclocking frequency by testing the CPU 104 under different loads until a frequency for the lightest load falls significantly below a target frequency when thermal intervention occurs.

The non-transitory machine-readable medium 100 may include a non-volatile memory, such as read-only memory (ROM), electrically-erasable programmable read-only memory (EEPROM), or flash memory. The medium 100 may include an electronic, magnetic, optical, or other physical storage device that encodes the overclocking instructions 102 that implement the functionality discussed herein.

The CPU 104 may include a number of processing cores 106. The CPU 104 may execute instructions to implement a basic input/output system (BIOS), an operating system (OS), and various applications. The CPU 104 may be connected to the non-transitory machine-readable medium 100 to obtain instructions to execute and store results of execution. The CPU 104 may also cooperate with a non-transitory machine-readable medium that includes a volatile memory, such as a random-access memory (RAM), that provides working memory during execution.

The overclocking instructions 102 may be directly executed, such as binary or machine code, and/or may include interpretable code, bytecode, source code, or similar instructions that may undergo additional processing to be executed. All of such examples may be considered executable instructions.

The non-transitory machine-readable medium 100, instructions 102, and CPU 104 may be installed as part of a computing device, such as a desktop computer, notebook computer, or AiO computer.

The overclocking instructions 102 may be executed by the CPU 104 or by another processor such as a microcontroller that may be referred to as an embedded controller (EC).

The overclocking instructions 102 set a target clock frequency 110 of the CPU 104. The target frequency 110 may be higher than the nominal frequency of the CPU 104. The target frequency 110 may be set by setting a frequency multiplier of the CPU 104. The target frequency 110 represents an attempt of determine an overclock frequency for the CPU 104.

The overclocking instructions 102 may increase the target frequency for the CPU 104 during a series of benchmark tests to determine a highest acceptable target frequency 110, which may be taken as the overclock frequency. Each iteration of the test may increase the target frequency by an increment. For example, if the CPU 104 has a nominal frequency of 4 GHz, then the target frequency 110 may be increased by successive increases of a frequency multiplier. For example, a frequency multiplier may start at 40 and be increased by 1 at each iteration. When increasing the target frequency of the CPU 104, a voltage of the CPU 104 may also be increased if the prior voltage is below a safe operating voltage for the increased target frequency 110.

For each target frequency 110, the overclocking instructions 102 benchmark 112 the CPU 104 under a first load 114 and a second load 116. Any suitable number of loads 114, 116 may be used with two being merely an example. The first load 114 is selected to be lighter than the second load 116. The first and second loads 114, 116 may be established by controlling different numbers of processing cores 106 to be active. As such, the first load 114 has fewer cores 106 active than the second load 116.

The benchmark or stress test may be based on Prime95, a prime number computation tool developed by George Woltman, or a similar program. The benchmark is to determine a sustained thermal effect of maximum core frequency for various levels of CPU load as determined by the number of active physical cores 106 of the CPU 104.

During a series of iterations of the stress test, a frequency for each level of CPU load corresponding to the target CPU frequency 110 is collected to determine the performance of the CPU 104. The overclocking instructions 102 apply the first load 114 by, for example, activating the corresponding number of cores 106 of the CPU 104, and then determine a first operating frequency 118 of the first load 114. The first operating frequency 118 may be the maximum frequency from the benchmark 112 under the first load 114. Then the overclocking instructions 102 apply the second load 116 by, for example, activating the corresponding number of cores 106 of the CPU 104, and then determine a second operating frequency 120 of the second load 116. The second operating frequency 120 may be the maximum frequency from the benchmark 112 under the second load 116.

A determined frequency 118, 120 may be termed an “operating” frequency in the sense that the CPU 104 operates under the benchmark 112. A frequency 118, 120 may be a “maximum” frequency determined during the benchmark 112 since a maximum or substantive maximum frequency is a useful output of the benchmark 112. A maximum frequency may be a maximum that is sustained or may be computed with a time average or moving average. The techniques discussed herein do not require a strict maximum frequency and may work sufficiently well with an operating frequency that is representative of or near enough to a maximum.

The frequencies 118, 120 determined for the loads 114, 116 may be stored as the loads 114, 116 are applied. During successive iterations of the benchmark 112, as the target frequency 110 is increased, the determined frequencies 118, 120 may also increase. The instructions 102 may track current maximums for the frequencies 118, 120. That is, the first frequency 118 may be taken as the maximum determined over a set of target frequencies 110 of the CPU 104 used for the benchmarks and, similarly, the second frequency 120 may be taken as the maximum determined over the set of target frequencies 110. Each of the frequencies 118, 120 may be maintained as a maximum over the series of benchmark iterations of a maximum frequency determined during each interaction.

The instructions 102 end the iterative performance of the benchmark 112 with increasing target frequency 110 when the operating frequency corresponding to the lightest load 114, that is the first operating frequency 118, is lower than the target frequency 110 by a margin 124 and when a thermal condition 122 of the CPU 104 had been met. When these frequency and thermal conditions are met, the instructions 102 store the first operating frequency 118 and the second operating frequency 120 as overclocked frequencies for continued operation of the CPU 104.

When the frequency and thermal conditions are not met, the instructions 102 increase the target frequency 110 and repeat the benchmark 112 to redetermine the first operating frequency 118 and the second operating frequency 120 until the frequency and thermal conditions are met.

The frequency condition may compare the maximum frequency under the lowest load, i.e., the first operating frequency 118 corresponding to the first load 114, to the target frequency 110. If the maximum frequency under the lowest load falls below the target frequency 110 by a margin 124, then the frequency condition is considered met. The margin 124 may be between 10% and 20%, for example 15%. For example, if the margin is 15% and the target frequency is 4.6 GHz, then a corresponding threshold frequency is 3.91 GHz (i.e., 85% of 4.6 GHz). If the measured maximum frequency under the lowest load falls below 3.91 GHz, then the frequency condition is met. If the measured maximum frequency is above 3.91 GHz, then the frequency condition is not met.

Maximum frequency is a reliable indicator for measuring system performance. Unlike a benchmark score, maximum frequency is consistent and able to reflect a more accurate status of the CPU 104 responding to thermal effects.

The thermal condition 122 indicates that the CPU 104 is at an elevated thermal state compared to an expected, safe, or desired thermal state. The thermal condition 122 may include CPU temperature exceeding a threshold temperature or thermal throttling of the CPU exceeding a threshold thermal throttling. An example threshold temperature is 85 degrees C. An example threshold thermal throttling may be a number of thermal throttling events per unit time (e.g., 5 events per 1 minute), such as a number of acceptable PROCHOT # assertions over a duration of time.

The combination of the thermal condition 122 and frequency condition, as defined by the margin 124, indicates that the drop in operating frequency 118 relative to the target frequency 110 is due to thermal effects. Hence, any increase in target frequency 110 will likely exacerbate thermal effects and will unlikely result in an appreciable increase to the operating frequencies 118, 120. Thus, stable overclocking is achieved.

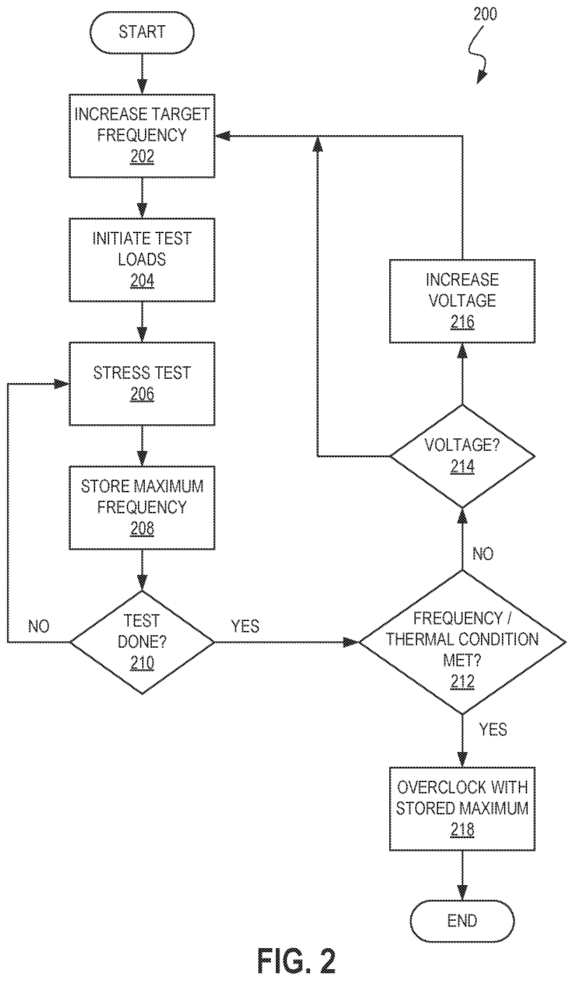

FIG. 2 shows an example method 200 to determine a CPU overclocking frequency by testing the CPU under different loads until a frequency for the lightest load falls significantly below a target frequency when thermal intervention is detected. The method 200 may be implemented by processor-executable instructions stored at a non-transitory machine-readable medium, such as discussed above with regard to FIG. 1.

The method 200 iterates over a series of increasing target clock frequencies for the CPU to be overclocked. At block 202, a target frequency of the CPU is set to a value greater than the previous value used during the previous iteration. For the first iteration, the target frequency may be set to an initial value above the nominal frequency of the CPU. A frequency multiplier may be used to set the target frequency.

At block 204, execution of different test loads by the CPU is initiated. Different physical processing cores of the CPU may be activated to establish the different test loads. For example, a first test load may have one core turned on, a second test load may have two cores turned on, and so on. One of the test loads is considered the lowest or lightest, for example, a test load with the fewest number of active cores.

At block 206, a benchmark or stress test is performed with the test loads and a maximum frequency of the CPU for each test load of the different test loads is stored, at block 208, until completed via block 210. Each load may be applied and stress tested in any sequence, via blocks 206-210, until all loads for the current target frequency have been tested. Maximum frequencies for different levels of CPU loading ranging from lowest to highest are obtained. During subsequent iterations, block 208 compares a previous maximum frequency for each test load with a currently determined maximum frequency for the test load and takes the highest. Hence, a running maximum frequency for each test load is maintained over iterations of increasing target frequency.

At block 212, it is determined whether a condition of the CPU has been reached during the current iteration. The condition may include a frequency condition and a thermal condition.

A frequency condition may be based on the maximum frequency, determined at block 208, of the lowest test load. The frequency condition may compare the maximum frequency of the lowest test load to a threshold frequency. The threshold frequency may be a margin lower than the target frequency of the current iteration, for example 10% to 20% lower. If the maximum frequency of the lowest test load falls below the threshold frequency, then the frequency condition is met.

A thermal condition may include detecting a CPU temperature exceeding a threshold temperature, detecting thermal throttling of the CPU exceeding a threshold degree of thermal throttling, or otherwise determining that the CPU is at an elevated thermal state. The thermal condition is met if the CPU is at an elevated thermal state.

If the condition of block 212 is not yet reached, then another iteration of the method 200 is performed with an increased target frequency, at block 202, and the stress testing and maximum frequency determination is repeated. There is room to increase the target frequency to gain increased overclocking because thermal effects are not yet dominant.

When increasing the target frequency of the CPU during a subsequent iteration, a safe operating voltage may be checked, at block 214, and the voltage of the CPU may be increased if too low, at block 216. CPU voltage should not be set too low to avoid crashing the CPU and should not be set too high to avoid damaging the CPU.

At block 212, when the condition of the CPU has been reached, iteration over the series of increasing target clock frequencies is ceased. At block 218, the CPU may now be overclocked based on the maximum frequency of the CPU for each test load for the current iteration, determined at block 208. The method 200 then ends.

It should be noted that other data may be obtained during the stress test of the CPU and such data may also be used to configure the CPU.

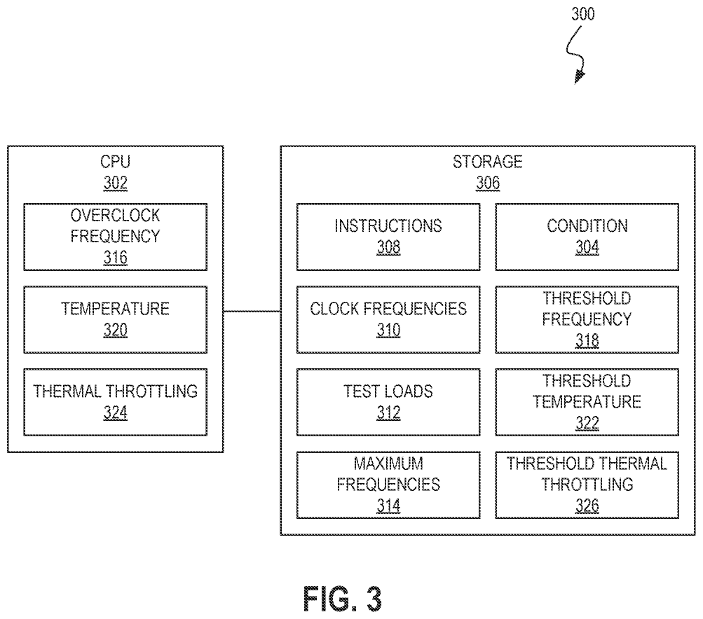

FIG. 3 shows an example device 300 to determine a CPU 302 overclocking frequency by testing the CPU 302 under different loads until a condition 304 is reached. The device 300 may be a computing device such as a desktop computer, notebook computer, or All-in-One (AiO) computer.

The device 300 includes the CPU 302 and storage 306 connected to the CPU 302. The CPU 302 is a multi-core processor. The storage 306 includes a non-transitory machine-readable medium, such as a non-volatile memory. The device 300 may also include volatile memory connected to the CPU 302.

The storage 306 stores executable instructions 308 that cause the CPU 302 to determine a safe or reliable overclocking frequency. The CPU 302 executes the instructions 308 to iterate over a series of increasing clock frequencies 310, which may be provided with corresponding increasing voltages. At each frequency 310, the CPU 302 initiates execution of different test loads 312. A maximum frequency 314 reached by the CPU 302 for each test load 312 is stored. The CPU 302 evaluates the condition 304 based on the maximum frequency 314 of a test load 312. When the condition 304 has been reached, the CPU 302 ceases iteration over the series of increasing clock frequencies 310 and sets an overclock frequency 316 based on the maximum frequency 314 for each test load 312.

The condition 304 may include detecting that the maximum frequency 314 of a lowest test load 312 is below a threshold frequency 318. The threshold frequency 318 may be between 10% and 20% lower than a clock frequency 310 for the CPU 302 for the current iteration.

The condition 304 may further include detecting a temperature 320 of the CPU 302 exceeding a threshold temperature 322, detecting thermal throttling 324 of the CPU 302 exceeding a threshold thermal throttling 326, or a combination of such.

The condition 304 thereby provides for a safe or reliable overclocking frequency 316 for the CPU 302.

In view of the above, it should be apparent that a CPU may be overclocked in a fast and reliable way with reduced or eliminated crashing and a reduced or eliminated need to collect data about the system.

It should be recognized that features and aspects of the various examples provided above can be combined into further examples that also fall within the scope of the present disclosure. In addition, the figures are not to scale and may have size and shape exaggerated for illustrative purposes.

1. A non-transitory machine-readable medium comprising instructions that, when executed by a processor, cause the processor to:
set a target frequency of a central processing unit (CPU);
benchmark the CPU under a first load and a second load, wherein the first load is lighter than the second load;
determine a first operating frequency of the first load and second operating frequency of the second load; and
if the first operating frequency is lower than the target frequency by a margin and a CPU thermal condition had been met, then store the first operating frequency and the second operating frequency for continued operation of the CPU, otherwise repeat the benchmark and redetermine the first operating frequency and the second operating frequency until the first operating frequency is lower than the target frequency by the margin and the CPU thermal condition is met.

2. The non-transitory machine-readable medium of claim 1, wherein the instructions are to:
determine the first operating frequency as a first maximum frequency from the benchmark under the first load; and
determine the second operating frequency as a second maximum frequency from the benchmark under the second load.

3. The non-transitory machine-readable medium of claim 2, wherein:
the first maximum frequency is a maximum over a set of target frequencies of the CPU used in the benchmark; and
the second maximum frequency is a maximum over the set of target frequencies of the CPU used in the benchmark.

4. The non-transitory machine-readable medium of claim 1, wherein the CPU thermal condition comprises:
a CPU temperature exceeding a threshold temperature; or
a thermal throttling of the CPU exceeding a threshold thermal throttling.

5. The non-transitory machine-readable medium of claim 1, wherein the margin is between 10% and 20%.

6. A device comprising:
a central processing unit (CPU);
storage connected to the CPU, the storage including executable instructions to:
iterate over a series of increasing clock frequencies for the CPU;
initiate execution of different test loads by the CPU and store a maximum frequency of the CPU for each test load of the different test loads;
determine that a condition of the CPU has been reached based on the maximum frequency of a test load of the different test loads; and
when the condition of the CPU has been reached, cease iteration over the series of increasing clock frequencies and overclock the CPU based on the maximum frequency of the CPU for each test load.

7. The device of claim 6, wherein the instructions are to detect that the maximum frequency of a lowest test load of the different test loads is below a threshold frequency to determine that the condition of the CPU has been reached.

8. The device of claim 7, wherein the threshold frequency is between 10% and 20% lower than a clock frequency for the CPU for a current iteration.

9. The device of claim 7, wherein the instructions are to:
detect a CPU temperature exceeding a threshold temperature, or
detect thermal throttling of the CPU exceeding a threshold thermal throttling,
so as to determine that the condition of the CPU has been reached.

10. The device of claim 6, wherein the instructions are to increase CPU voltage when increasing a clock frequency for the CPU.

11. A method comprising:
setting a target frequency of a central processing unit (CPU);
stress testing the CPU under a first load and a second load, wherein the first load is lower than the second load, to determine a first maximum frequency of the first load and second maximum frequency of the second load;
determining whether a condition of the CPU has been reached based on the first maximum frequency of the first load;
if the condition of the CPU has not been reached, increasing the target frequency of the CPU and repeating the stress testing and determining; and
if the condition of the CPU has been reached, overclocking the CPU based on the first maximum frequency and the second maximum frequency.

12. The method of claim 11, wherein determining whether the condition of the CPU has been reached further includes determining the CPU to be at an elevated thermal state.

13. The method of claim 11, further comprising, when increasing the target frequency of the CPU, increasing a voltage of the CPU if below a safe operating voltage for the target frequency.

14. The method of claim 11, further comprising:
determining the first maximum frequency as a highest frequency of the first load over increasing target frequencies of the CPU; and
determining the second maximum frequency as a highest frequency of the second load over the increasing target frequencies of the CPU.

15. The method of claim 11, further comprising activating different processing cores of the CPU to establish the first load and the second load.
